(19) United States
(12) Patent Application Publication
(10) Pub. No.: US 2010/0121712 A1
(43) Pub. Date: May 13, 2010

(54) DIVERSITY OF ADS DISPLAYED ON A PUBLISHER PAGE

(75) Inventors: Ben Shahshahani, Menlo Park, CA (US); Vanja Josifovski, Los Gatos, CA (US); Peiji Chen, Saratoga, CA (US); Zengyan Zhang, San Jose, CA (US); Jianchang (JC) Mao, San Jose, CA (US); Ruofei (Bruce) Zhang, San Jose, CA (US); Sanjay Kshetramade, Fremont, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/269,383

(22) Filed: Nov. 12, 2008

(51) Int. Cl. G06F 17/30; G06Q 30/00

(52) U.S. Cl. 705/14.54; 705/10

(57) ABSTRACT

A system for selecting advertisements for a web page. An advertisement request is received and the web page content is evaluated to identify a first advertisement query based on the content of the web page and a second advertisement query based on the content of the web page or a behavioral feature. A first set of advertisements is retrieved based on the first advertisement query and a second set of advertisements is retrieved based on the second advertisement query. The first set of advertisements is blended with the second set of advertisements to form a blended advertisement set. The blended advertisement set is provided for display with the web page.

### BACKGROUND

One form of revenue for search engines and content providers are advertisements that are displayed on the pages of websites. These advertisements may take the form of banner advertisements, advertisement lists, or other commonly known advertisements. One form of advertising on web pages is referred to as contextual advertisement. In contextual advertising, advertisements are requested for a specific web page based on the content of that web page. The web page content is analyzed to identify which advertisements best match the content for the web page. Typically, one drawback of contextual advertising is that each of the advertisements for a particular web page are quite similar. If all of the advertisements are similar, it is less likely that user will visit each of the advertisements presented on the web page.

### SUMMARY

The present application describes a system and method for selecting advertisements for a web page.

The system includes an analysis engine, a policy module, and an advertisement engine. The analysis engine receives an advertisement request and evaluates the web page content to identify a first advertisement query based on the content of the web page and a second advertisement query based on the content of the web page or a behavioral feature. The advertisement engine retrieves a first set of advertisements based on the first advertisement query and a second set of advertisements based on the second advertisement query. The policy module receives the first and second sets of advertisements from the advertisement engine. The policy module blends the first set of advertisements and the second set of advertisements into a blended advertisement set. The blended advertisement set is provided to the web page server for display with the web page.

Other systems, methods, features and advantages will be, or will become, apparent to one with skill In the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

FIG. 1 is a schematic view of a system for selecting advertisements for a web page;

FIG. 2 is a flow chart illustrating a method for selecting advertisements for a web page;

FIG. 3 is a flow chart illustrating another method for selecting advertisements for a web page: and

FIG. 4 is a schematic view of a computer system for implementing the methods described.

### DETAILED DESCRIPTION

The system described in the present application improves the diversity of advertisements for contextual advertising. The system identifies one or more matching dimensions of user behavior, page content, and/or advertisement content. As such, the ads shown on web pages can be relevant to multiple dimensions, including for example user behavior targeting features, multiple topics on the web page, or publisher specified keywords, instead of showing ads all matching a dominant dimension.

As described above it is possible, in contextual advertising, that the advertisements displayed for a given page are very similar to each other, and mostly dominated by a few strongest features. If this dominant topic is not relevant to the user intent, the user will be less likely to click on any advertisement thus negatively affecting the click through rate (CTR).

To address these issues the system may increase the diversity of the advertisements served to a web page by executing multiple queries across different dimensions, such as user behavioral targeting (BT) categories, page content, and publisher supplied keywords (or hints). One method of increasing diversity includes (i) selection of multiple dimensions, (ii) formation of multiple queries based on selected dimensions, (iii) execution of multiple queries to retrieve ads candidates from each dimension, and (iv) blending of multiple result sets so that both the quality of particular ads and the diversity of the ads returned to the web page server are maximized. The selection method can be extended by configuring dimension importance to customize the advertisement mix for different pages or publishers. For pages having diverse topics, multiple content queries may be generated by clustering features based on their closeness to a topic. The method can be applied to the selection of both contextual ads and banner ads.

In addition, the system may cluster the result advertisements to increase diversity. The clustering may be based on an advertisement attribute, for example, advertisement category, or the clustering may be based on a dominant feature in the page-ad matching (i.e., the feature making the maximum contribution to the final score). Unlike the existing result set clustering algorithms, which are done in the post-processing stage and require retrieval of a large number of results, the proposed solution may be implemented at the index traversal time by maintaining multiple heaps of candidates. Each heap contains candidates from one cluster.

The result clustering would be useful where a single dominant topic exists on the page, for example, San Francisco on a weather channel page. The multiple advertisement result sets in this case could be, San Francisco Real Estate, San Francisco Travel, etc.

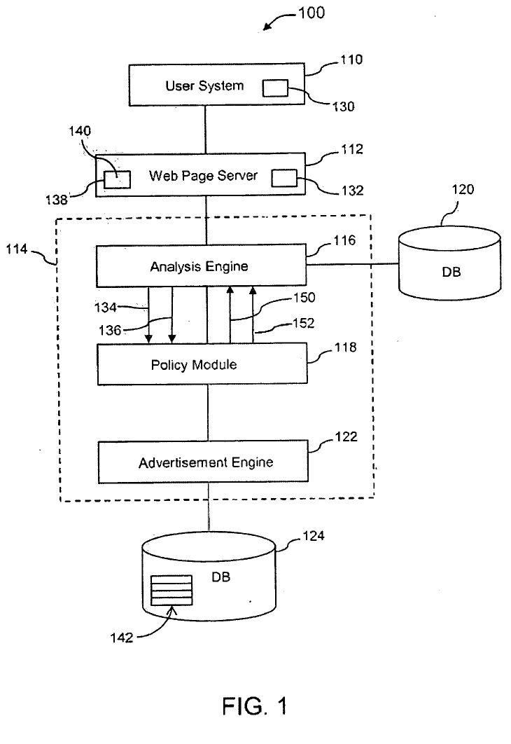

Now referring to FIG. 1, a system 100 is provided for selecting advertisements. The system 100 includes an advertisement server 114 with an analysis engine 116, a policy module 118, and an advertisement engine 122. A user system 110 may request a web page 138 from a web page server 112. The web page server 112 will, in turn, request one or more advertisements 142 from an advertisement server 114.

In a common example, the web page server 112 is accessed by a user system 110 that requests a web page 138. The user system 110 communicates over a wide area network such as the internet with the web page server 112. Accordingly, the web page server 112 provides the user system 110 with a web page 138 including web page content 140 and/or an executable code such as Java Script for use in the user system 110. As described above, many web pages will display advertisements to the user. As such, the web page server 112 may request advertisements 142 from the advertisement server 114 over an Internet connection. The advertisement server 114 may have access to the web page content 140 with which the advertisements 142 may be placed. Accordingly, the advertisement server 114 may identify words or phrases from the web page content 140 that are used to infer the interests of the user and serve advertisements 142 related to the interests of the user.

The advertisement server 114 may include an analysis engine 116, a policy module 118, and an advertisement engine 122. The analysis engine 116 accesses the web page content 140 and Identifies one or more advertisement queries for the web page 138 based on the web page content 140. In addition, the analysis engine 116 may be in communication with the web page server 112 to receive user Information such as a browser history or user preferences to generate advertisement queries. The user information may be stored in a cookie 130 on the user system 110 or in a database on the web server 112 based on a registration id 132 related to the current browser session.

While a first advertisement query 134 and a second advertisement query 136 are identified by two lines, multiple additional queries may also be included for each web page. Further, the advertisement queries may be transmitted along the same communication medium, and even within the same or multiple messages. The analysis engine 116 may also analyze user preference information based on the cookie 130 or registration id 132 to determine other advertisement queries based on user behavior. The content queries and the behavioral queries are then provided to the policy module 118. The analysis engine 116 may also access a database 120 that identifies a category for each query based on advertisement taxonomy.

The policy module 118 may, then, determine the proportion of each query relative to the number of advertisements requested. Further, the policy module 118 may determine the frequency for each query. In one example, ten advertisements are requested by the web page server 112 for the web page 138. The analysis module 116 identifies one content query and one behavioral query, while the policy module may determine that seventy percent of the requested advertisements will be selected from the content query and thirty percent of the advertisements will be selected from the behavioral query. As such, the top seven server results from the content query and the top three results from the behavioral query are retrieved. In addition, the policy module 118 may determine the order in which each advertisement is provided.

For example, the policy module 118 may determine to provide a content-related advertisement then a behavioral-related advertisement, in alternating order until all of the behavioral advertisements are used. Alternatively, the policy module may systematically distribute the advertisement across the series of advertisements. For example, one behavioral, two content, one behavioral, two content until each of the advertisements are used. As such, the cluster of content related advertisements may be separated to provide better geographic distribution on the web page. To facilitate the example described above, the policy module 118 is in communication with the advertisement engine 122 to provide each query to the advertisement engine 122. The advisement engine 122 then searches the advertisement database 124 based on each of the queries and provides the results of each query back to the policy module 118. Therefore, in the example provided, first result set 150 is provided based on the first advertisement query 134 and a second result set 152 is provided based on the second advertisement query 136. As described above, the policy module 118 selects the frequency and order for each advertisement to be provided back to the web page server 112.

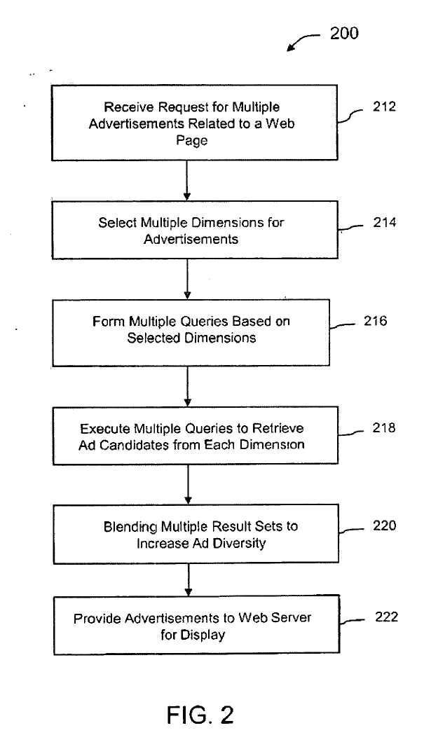

Now referring to FIG. 2, a method 200 for selecting advertisements is provided. In block 212, a request is received for multiple advertisements related to a web page. In block 214, multiple dimensions are selected for advertisements based on the web page content and or user information. In block 216, multiple queries are formed according to each selected dimension. The selected dimensions may include one or more content-based dimensions and/or one or more behavioral-based dimensions. In addition, the system may use a predetermined target number of dimensions, such that, other dimensions are used to fill in, if not enough content dimensions are identified. For example, if only two content dimensions are identified and the target is three dimensions, then one behavioral dimension may be used for a total of three dimensions. For content-based dimensions the queries may be based on keywords identified in the web page content or related taxonomies. For behavioral-based dimensions the queries may be determined according to user preferences or browser history, as described above.

The system may, then, execute the multiple queries to retrieve advertisement candidates from each dimension, as denoted in block 218. In block 220, the multiple results sets may be blended to increase advertisement diversity. The results sets may be blended based on a pre-defined frequency model or series, such as seventy percent content and thirty percent behavioral. In addition, diversity may be increased by controlling the specific sequence of the blending, for example, using a “round robin format” by alternating result sets in order or using a randomization format. The slate of blended advertisements may be provided to the web server for display to the user, as denoted by block 222.

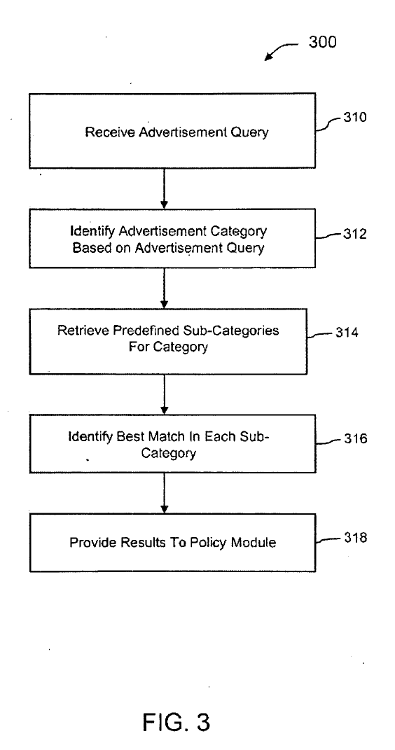

Now referring to FIG. 3, a method 300 is provided for clustering advertisements in block 310, an advertisement query is received by the advertisement engine. The advertisement engine then identifies advertisement categories based on the advertisement query, as denoted by block 312. The categories may be pre-defined according to an advertisement taxonomy. In block 314, the advertisement engine retrieves pre-defined subcategories for the identified category. In one example, the advertisement query may include San Francisco and weather, where San Francisco is a dominant feature. As such, the category would be defined as San Francisco and the subcategories may be defined as San Francisco-real estate or San Francisco-travel. In block 316, the advertisement engine identifies the best match to the advertisement query in each subcategory. Accordingly, each advertisement may be stored in the advertisement database and may be indexed based on the category and subcategory. The increase in diversity of the result set happens automatically as the results are retrieved, rather than in a post processing-step. Sorting the results in a post processing step would require retrieval of many records to ensure a diverse set and a second step of categorizing the records in real time. These additional steps would take significant time as advertisement service time and which would not lead to an efficient process.

In block 318, the result set is provided to the policy module where the results may be blended, for example by mixing or ordering with other dimensions. The policy module may then provide the advertisement results to the web page server in accordance with the pre-defined policy module rules.

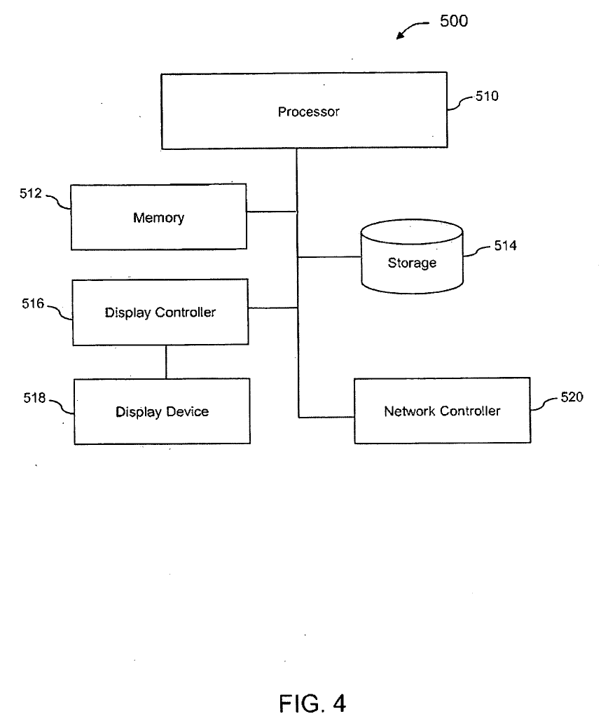

Any of the modules, servers, or engines described may be implemented in one or more general computer systems. One exemplary system is provided in FIG. 4. The computer system 500 Includes a processor 510 for executing instructions such as those described in the methods discussed above. The instructions may be stored in a computer readable medium such as memory 512 or a storage device 514, for example a disk drive, CD, or DVD. The computer may Include a display controller 516 responsive to instructions to generate a textual or graphical display on a display device 518, for example a computer monitor. In addition, the processor 510 may communicate with a network controller 520 to communicate data or instructions to other systems, for example other general computer systems. The network controller 520 may communicate over Ethernet or other known protocols to distribute processing or provide remote access to information over a variety of network topologies, including local area networks, wide area networks, the internet, or other commonly used network topologies.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

We claim:

1. A system for selecting advertisements for a web page served by a web page server, the system comprising:
an analysis engine receiving an advertisement request from the web page server, the analysis engine evaluating the web page served by the web page server to identify a first advertisement query based on content of the web page, the analysis engine also identifying a second advertisement query based on the content of the web page or a behavioral feature;
an advertisement engine receiving the first and second advertisement query and retrieving a first set of advertisements based on the first advertisement query and a second set of advertisements based on the second advertisement query, the advertisement engine providing the first and second sets of advertisements to the policy module; and
a policy module blending the first set of advertisements and the second set of advertisements into a blended advertisement set, the policy module providing the blended advertisement set to the web page server.

2. The system according to claim 1, wherein the policy module blends the first and second sets of advertisements based on a pre-defined ratio between the first and second set of advertisements.

3. The system according to claim 1, wherein the policy module determines an order of the first and second sets of advertisements based on a pre-defined ordering strategy.

4. The system according to claim 3, wherein the policy module determines an order of the first and second sets of advertisements by alternating between the first and second sets of advertisements.

5. The system according to claim 3, wherein the policy module determines an order of the first and second sets of advertisements by determining a sequence based on a ratio between the first and second sets of advertisements.

6. The system according to claim 1, wherein the analysis engine generates additional advertisement queries based on a pre -defined target number of dimensions.

7. The system according to claim 1, wherein the advertisement engine identifies clusters of advertisements based on an advertisement taxonomy.

8. The system according to claim 1, wherein the analysis engine identifies the second advertisement query based on a behavioral feature.

9. The system according to claim 8, wherein the analysis engine identifies the second advertisement query based on browser history.

10. The system according to claim 8, wherein the analysis engine identifies the second advertisement query based on user preferences.

11. A method for selecting advertisements for a web page served by a web page server, the method comprising:
receiving an advertisement request;
evaluating web page content;
identifying a first advertisement query based on the web page content;
identifying a second advertisement query based on the web page content or a behavioral feature;
retrieving a first set of advertisements based on the first advertisement query and a second: set of advertisements based on the second advertisement query;
blending the first set of advertisements and the second set of advertisements into a blended advertisement set; and
providing the blended advertisement set to the web page server.

12. The method according to claim 11, wherein the first and second sets of advertisements are blended based on a pre-defined ratio between the first and second set of advertisements.

13. The method according to claim 11, wherein a pre-defined ordering strategy is used to define an advertisement order of blended advertisement set.

14. The method according to claim 13, wherein the blended advertisements set is ordered by alternating between the first and second sets of advertisements.

15. The method according to claim 13, wherein the blended advertisements set is ordered by determining a sequence based on a ratio between the first and second sets of advertisements.

16. The method according to claim 11, further comprising generating additional advertisement queries based on a pre-defined target number of dimensions.

17. The method according to claim 11, further comprising Identifying clusters of advertisements based on an advertisement taxonomy.

18. The method according to claim 11, further comprising identifying the second advertisement query based on a behavioral feature.

19. The method according to claim 18, further comprising identifying the second advertisement-query based on browser history.

20. The method according to claim 18, further comprising identifying the second advertisement query based on user preferences.

21. A computer readable medium having stored therein instructions executable by a programmed processor for ranking results, the computer readable medium comprising instructions for:
receiving an advertisement request;
evaluating web page content;
identifying a first advertisement query based on the web page content;
identifying a second advertisement query based on the web page content or a behavioral feature;
retrieving a first set of advertisements based on the first advertisement query and a second set of advertisements based on the second advertisement query;
blending the first set of advertisements and the second set of advertisements into a blended advertisement set; and
providing the blended advertisement set to the web page server.

22. The computer readable medium according to claim 21, wherein the first and second sets of advertisements are blended based on a pre-defined ratio between the first and second set of advertisements.

23. The computer readable medium according to claim 21, further comprising generating additional advertisement queries based on a pre-defined target number of dimensions.

24. The computer readable medium according to claim 21, further comprising identifying clusters of advertisements based on an advertisement taxonomy.

25. The computer readable medium according to claim 21, further comprising identifying the second advertisement query based on a behavioral feature.
